(19) United States
(12) Patent Application Publication
(10) Pub. No.: US 2025/0256581 A1
(43) Pub. Date: Aug. 14, 2025

(54) FUEL CELL ELECTRIC VEHICLE

(71) Applicant: TOYOTA JIDOSHA KABUSHI KAISHA, Toyota-shi (JP)

(72) Inventor: Shinichiro IHORI, Toki-shi (JP)

(73) Assignee: TOYOTA JIDOSHA KABUSHI KAISHA, Toyota-shi (JP)

(21) Appl. No.: 19/024,388

(22) Filed: Jan. 16, 2025

(30) Foreign Application Priority Data
Feb. 8, 2024 (JP) 2024-017800

(51) Int. Cl. B60L 3/00; B60L 50/75

(52) U.S. Cl. CPC B60L 3/0007; B60L 50/75; B60L 2200/18

(57) ABSTRACT

In an electric vehicle including a frame fixed on a roof, a high-voltage cable, a bracket, and a hydrogen tank, the hydrogen tank is mounted on the frame so that the valve unit protrudes outward from the frame, and the bracket is bent and deformed inward when an impact force is applied from the outside, and stores the high-voltage cable 60 in a region located inside the outer end surface of the valve unit.

### CROSS REFERENCE TO RELATED APPLICATION

This application claims priority to Japanese Patent Application No. 2024-017800 filed on Feb. 8, 2024, which is incorporated herein by reference in its entirety including the specification, claims, drawings, and abstract.

### TECHNICAL FIELD

The present disclosure relates to a structure of a fuel cell electric vehicle in which a high voltage cable is routed on a roof.

### BACKGROUND

In recent years, fuel cell electric vehicles using hydrogen as fuel have been used. For example, JP 2009-18803A discloses a fuel cell mounting bus in which a hydrogen gas tank is mounted on a roof and a fuel cell is disposed in a rear portion of a vehicle.

### SUMMARY

Electric vehicles in which a gas fuel tank and high-voltage equipment are mounted on a roof have been studied. In such an electric vehicle, a high-voltage cable may be routed to a side portion on a roof. In this case, when the electric vehicle rolls, the high-voltage cable may come into contact with the ground and be damaged.

Therefore, an object of the present disclosure is to suppress damage to a high-voltage cable when an electric vehicle in which the high-voltage cable is routed on a roof rolls.

A fuel cell electric vehicle includes a frame fixed on a roof, and a high voltage cable routed along the frame in the vehicle longitudinal direction, and a bracket attached to the frame, the bracket extending outward in the vehicle width direction from the frame and configured to support the high voltage cable at the outside of the frame, and a gas fuel tank mounted on the frame such that a longitudinal direction of the gas fuel tank lies along the vehicle width direction, the gas fuel tank having a valve unit which is attached to an end, in the longitudinal direction, of the gas fuel tank. The gas fuel tank is mounted on the frame such that the valve unit protrudes further outward in the vehicle width direction than the frame. The bracket is bent and deformed toward the inside in the vehicle width direction when an impact force is applied from the outside in the vehicle width direction, to store the high-voltage cable in a region located inward of an outer end surface of the valve unit in the vehicle width direction.

Accordingly, when the fuel cell electric vehicle rolls, the high-voltage cable is stored in a region located inside the outer end surface of the valve unit due to bending deformation of the bracket, and the valve unit having high rigidity comes into contact with the ground surface, so that damage of the high-voltage cable due to contact with the ground surface can be suppressed.

In the fuel cell electric vehicle according to the present disclosure, the bracket may support the high voltage cable between an upper surface of the frame and a lower end of the valve unit and outside the outer end surface of the valve unit in the vehicle width direction, and the bracket may be bent and deformed toward the inside in the vehicle width direction when an impact force is applied from the outside in the vehicle width direction, to store the high voltage cable between the upper surface of the frame and the lower end of the valve unit and in the region located inward of the outer end surface of the valve unit in the vehicle width direction.

According to this configuration, when the fuel cell electric vehicle rolls over, the high-voltage cable is stored between the upper surface of the high-rigidity frame and the lower end of the high-rigidity valve unit, so that a high-voltage cable survival space at the time of rolling over is secured. Therefore, damage to the high-voltage cable when the fuel cell electric vehicle rolls can be suppressed.

In the fuel cell electric vehicle according to the present disclosure, the bracket may include a fixing portion fixed to an outer surface of the frame in the vehicle width direction, and a bent portion may be bent outwardly in the vehicle width direction from an upper end of the fixing portion, and an L-shaped cable support portion that is connected to an outer side of the bent portion in the vehicle width direction, may extend upward, and may be configured to hold the high-voltage cable on an outer side, in the vehicle width direction, of an upper portion. When an impact force is applied from the outside in the vehicle width direction, the cable support portion may be pivoted inwardly in the vehicle width direction about the bent portion, to store the high voltage cable in the region located inward of the outer end surface of the valve unit in the vehicle width direction.

With this configuration, when the fuel cell electric vehicle rolls and an impact force is input to the outside of the high voltage cable from the outside in the vehicle width direction, a rotation moment is input to the bent portion. As a result, the cable support portion rotates inward about the bent portion. And the cable support portion stores the high-voltage cable in a region located inside the outer end surface of the valve unit. As a result, damage to the high-voltage cable when the fuel cell electric vehicle rolls over can be suppressed.

In the fuel cell electric vehicle according to the present disclosure, the bracket may include a fixing portion fixed to an outer surface of the frame in the vehicle width direction, and a bent portion may be bent outwardly in the vehicle width direction from an upper end of the fixing portion, and an L-shaped cable support portion connected to an outer side of the bent portion in the vehicle width direction, extending upward, and may configured to hold the high voltage cable on an outer side, in the vehicle width direction, of an upper portion. The cable support portion may include a lateral plate connected to the bent portion and extending in the vehicle width direction, and a vertical plate extending upward from the lateral plate and configured to hold the high-voltage cable on an outer side of an upper portion in a vehicle width direction. The thickness of the upper half of the vertical plate may be smaller than the thickness of the lower half, and when an impact force is applied from the outside in the vehicle width direction, the upper half portion mat be pivoted inwardly in the vehicle width direction about a boundary between the upper half portion and the lower half portion, to store at least a portion of the high-voltage cable between the upper surface of the frame and the lower end of the valve unit and in the region located inward of the outer end surface of the valve unit in the vehicle width direction.

In this way, the cable support portion rotates inward at the boundary between the upper half portion and the lower half portion of the cable support portion, and stores the high-voltage cable inside the landing ground entering line in the vehicle width direction. As a result, damage to the high-voltage cable when the fuel cell electric vehicle rolls over can be suppressed.

In the fuel cell electric vehicle according to the present disclosure, after the upper half portion rotates inward about a boundary between the upper half portion and the lower half portion when an impact force is applied from an outer side in a vehicle width direction, a frame support portion including the lower half portion and the horizontal plate may rotate inward about the bent portion, and the high voltage cable may be stored in a region located between an upper surface of the frame and a lower end of the valve unit and inside the outer end surface of the valve unit in the vehicle width direction.

In this way, the cable support portion can be stored in the gap between the upper surface of the frame and the lower end of the valve unit so as to fold the cable support portion by rotating the cable support portion inward about the two portions of the curved portion and the boundary between the upper half portion and the lower half portion of the cable support portion.

According to the present disclosure, it is possible to suppress damage to the high-voltage cable when the fuel cell electric vehicle in which the high-voltage cable is wired on the roof rolls.

### BRIEF DESCRIPTION OF DRAWINGS

FIG. 1 is a right side view of an electric vehicle according to an embodiment;

FIG. 2 is a plan view of a power generation unit mounted on the electric vehicle according to the embodiment;

FIG. 3 is a right side view of the power generation unit mounted on the electric vehicle according to the embodiment;

FIG. 4 is a cross-sectional view of the electric vehicle according to the embodiment, and is a cross-sectional view taken along line A-A shown in FIG. 1, illustrating deformation of the bracket when the electric vehicle rolls over;

FIG. 5 is a cross-sectional view of a bracket and a high-voltage cable of an electric vehicle according to another embodiment of the present disclosure, illustrating deformation of the bracket when the electric vehicle rolls;

FIG. 6 is a cross-sectional view of a bracket and a high-voltage cable of an electric vehicle according to another embodiment of the present disclosure, illustrating deformation of the bracket when the electric vehicle rolls.

### DESCRIPTION OF EMBODIMENTS

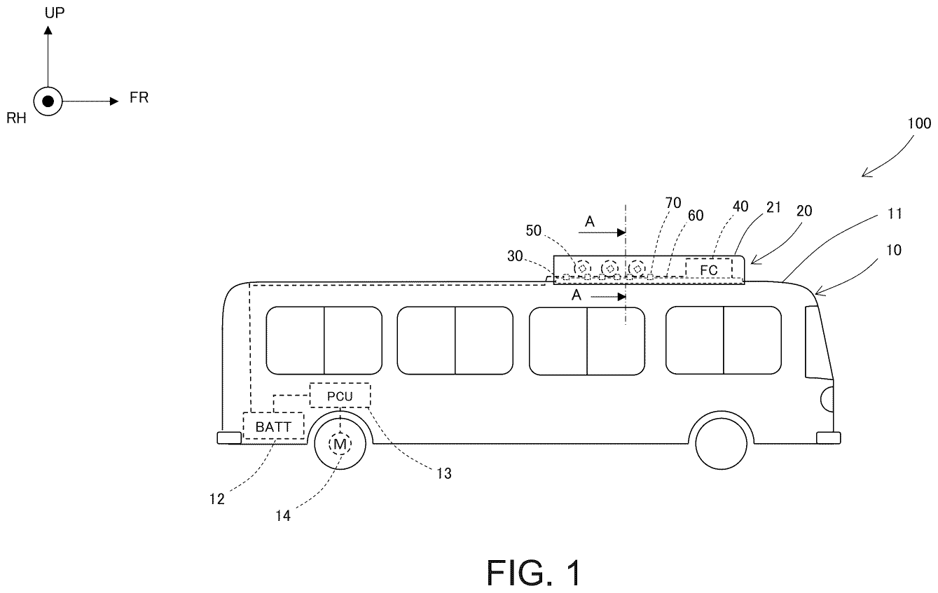

Hereinafter, an electric vehicle 100 according to an embodiment will be described with reference to the drawings. As shown in FIG. 1, an electric vehicle 100 includes a body 10, a power generation unit 20, a high-voltage battery 12, a power control device (hereinafter referred to as a PCU) 13, and a driving motor 14. In the following description, the electric vehicle 100 will be described as an electric bus that is a fuel cell electric vehicle. Note that FR, UP, and RH shown in the drawings indicate a front side, an upper side, and a right side of the electric vehicle 100, respectively. The opposite directions of FR, UP, and RH indicate the rear side, the lower side, and the left side, respectively. Hereinafter, in the case where the front-rear direction, the left-right direction, and the up-down direction are simply used, the front-rear direction, the left-right direction, and the up-down direction of the electric vehicle 100 are indicated unless otherwise specified.

The power generation unit 20 includes a frame 30, an FC module 40, a hydrogen tank 50, a high-voltage cable 60, a bracket 70, and a casing 21. The frame 30 is fixed on the roof 11. The FC module 40 and the hydrogen tank 50 are mounted on the frame 30. The high-voltage cable 60 is routed along the frame 30 in the vehicle front-rear direction. The bracket 70 is attached to the frame 30 to support the high-voltage cable 60. The power generation unit 20 is covered by a casing 21.

The hydrogen tank 50 is a gas fuel tank that stores hydrogen gas as gas fuel. The FC module 40 is a fuel cell module that generates power using hydrogen gas supplied from the hydrogen tank 50 as fuel. The electric power generated by the FC module 40 charges the high-voltage battery 12 at the rear portion of the electric vehicle 100 by the high-voltage cable 60, and is supplied from the PCU 13 to the driving motor 14. The driving motor 14 drives wheels to drive the electric vehicle 100.

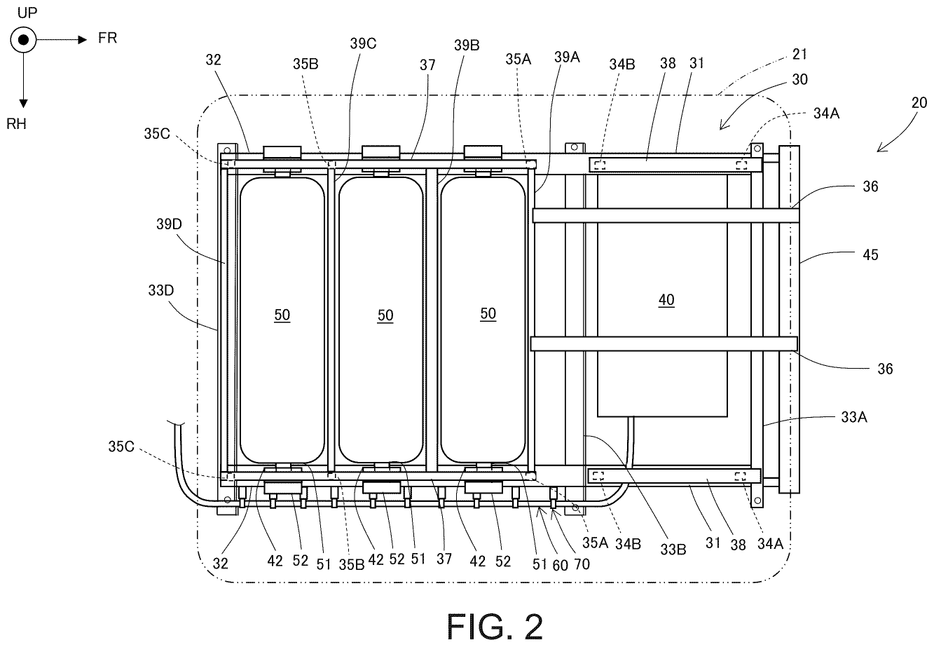

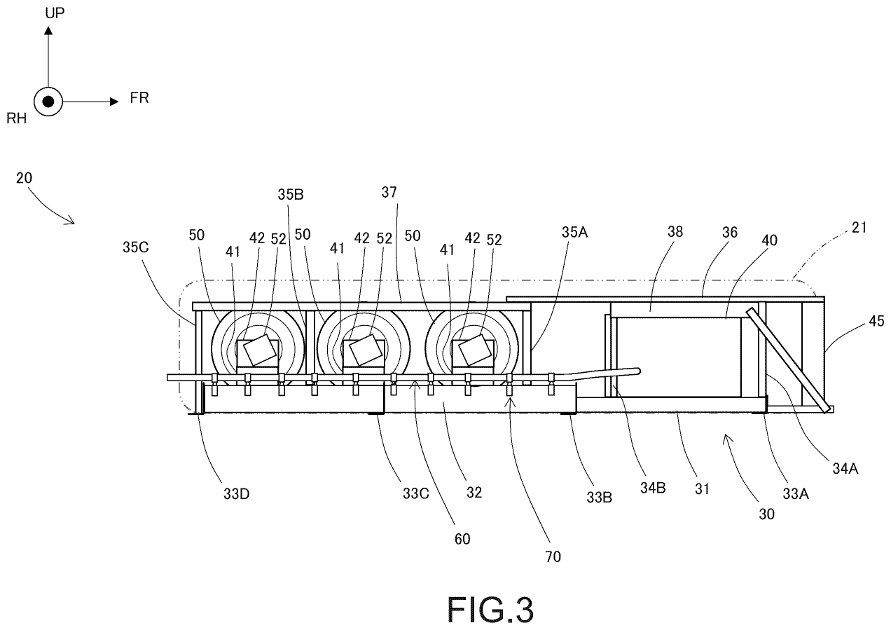

Next, a detailed structure of the power generation unit 20 will be described with reference to FIGS. 2 to 4. As shown in FIGS. 2 to 4, the frame 30 includes left and right front rails 31, left and right rear rails 32, first to fourth cross members 33A to 33D, left and right first and second columns 34A and 34B, left and right third to fifth columns 35A, 35B, and 35C, left and right front upper rails 38, left and right rear upper rails 37, an upper connecting member 36, and upper first to upper fourth cross members 39A, 39B, 39C and 39D.

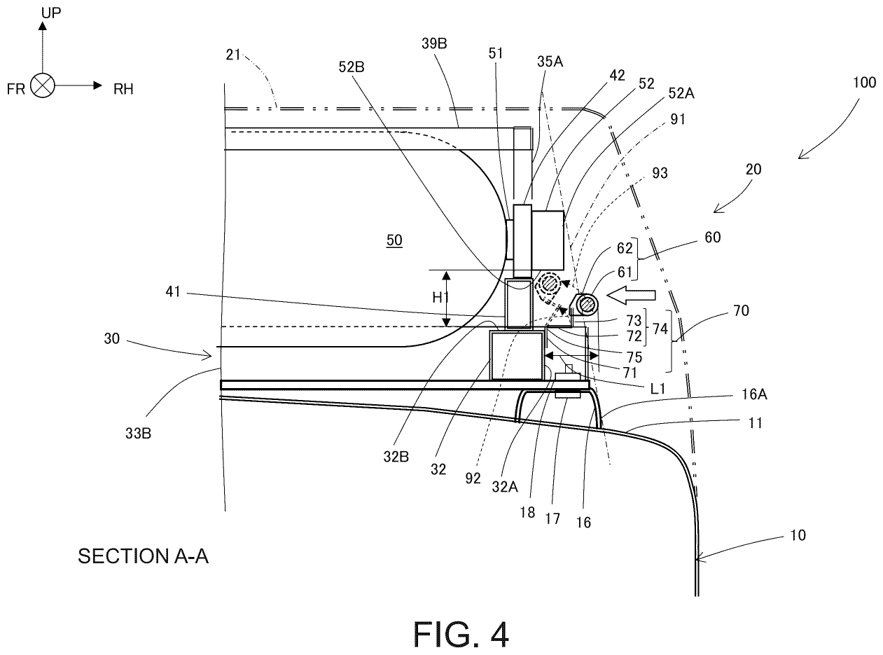

The left and right front rails 31 and the left and right rear rails 32 are connected to each other in the vehicle front-rear direction. The height of the rear rail 32 is greater than the height of the front rail 31. As shown in FIG. 4, the rear rail 32 is a quadrangular closed cross-sectional member. Similarly to the rear rail 32, the front rail 31 is also a quadrangular closed cross-sectional member.

The first cross member 33A is an L-shaped cross-sectional member that connects the left and right front rails 31 in the vehicle width direction. The second cross member 33B is an L-shaped cross-sectional member that connects the front ends of the left and right rear rails 32 in the vehicle width direction. The third and fourth cross members 33C and 33D are L-shaped cross-sectional members that connect the left and right rear rails 32 in the vehicle width direction at the center and the rear end of the rear rail 32. The left and right front rails 31, the left and right rear rails 32, and the first to fourth cross members 33A to 33D form a square grid frame. As shown in FIG. 4, left and right mounting rails 16 are fixed on the roof 11, and left and right end portions of the first to fourth cross members 33A to 33D are fixed to the left and right mounting rails 16 by bolts 17 and nuts 18.

The left first column 34A stands on a front end portion of the left front rail 31. The left second column 34B stands on the rear end portion of the left front rail 31. The upper ends of the first and second columns 34A and 34B are connected by a left front upper rail 38. The left third to fifth columns 35A, 35B, and 35C are erected on the front portion, the center portion, and the rear portion of the left rear rail 32. The upper ends of the third to fifth columns 35A, 35B, and 35C are connected by a left rear upper rail 37. The right first column 34A, second column 34B, front upper rail 38, third to fifth columns 35A, 35B, and 35C, and rear upper rail 37 have the same structures as the left columns and rails. The upper first to upper fourth cross members 39A, 39B, 39C and 39D connect the left and right rear upper rails 37.

The FC module 40 is mounted in a region surrounded by the left front rail 31, the right front rail 31, the first cross member 33A, and the second cross member 33B. A radiator 45 is mounted in front of the left and right front rails 31. The two upper connecting members 36 connect the upper first cross member 39A and the upper portion of the radiator 45 in the vehicle front-rear direction. Three hydrogen tanks 50 are mounted in a region surrounded by the left rear rail 32, the right rear rail 32t, the second cross member 33B, and the fourth cross member 33D so that the longitudinal direction thereof is along the vehicle width direction.

The hydrogen tank 50 is a cylindrical elongated member having hemispherical end plates attached to both ends thereof. A nozzle 51 protruding in the longitudinal direction is attached to the center of the end plates at both ends. The nozzle 51 communicates with the inside of the hydrogen tank 50. A valve unit 52 is attached to a longitudinal end of the nozzle 51. As described above, the valve unit 52 is attached to the end portion of the hydrogen tank 50 in the longitudinal direction and protrudes outward in the vehicle width direction from the end portion of the hydrogen tank 50. The hydrogen gas stored in the hydrogen tank 50 is supplied to the FC module 40 through the nozzle 51 and the valve unit 52. The hydrogen gas is filled into the hydrogen tank 50 through the valve unit 52 and the nozzle 51.

Left and right pedestals 41 are fixed to upper portions of the left and right rear rails 32. Left and right fixing clamps 42 for fixing the nozzle 51 of the hydrogen tank 50 by sandwiching the nozzle from above and below are attached to the left and right pedestals 41. The hydrogen tank 50 is fixed on the left and right rear rails 32 by fixing the left and right nozzles 51 to the left and right fixing clamps 42. In this manner, the hydrogen tank 50 is fixed to the left and right rear rails 32 so that the longitudinal direction thereof is disposed along the vehicle width direction.

As shown in FIG. 4, when the hydrogen tank 50 is fixed to the left and right rear rails 32, the outer end surfaces 52A of the valve units 52 protrude further outward in the vehicle width direction than the outer surfaces 32A of the left and right rear rails 32.

The high-voltage cable 60 includes a cable main body 61 and a clamp 62 fixed to the outer periphery of the cable main body 61. The high-voltage cable 60 is routed along the frame 30 in the vehicle front-rear direction.

The bracket 70 is attached to the frame 30 and extends outward from the frame 30 to support the high-voltage cable 60 outside the frame 30. The bracket 70 is a strip-shaped bent plate member including a fixing portion 71, a bent portion 75, and a cable support portion 74. The fixing portion 71 is a flat plate portion fixed to the outer surface 32A of the rear rail 32. An upper end of the fixing portion 71 protrudes slightly upward from the upper surface 32B of the rear rail 32. The bent portion 75 is a portion bent outward from the upper end of the fixing portion 71. Since the upper end of the fixing portion 71 protrudes slightly upward from the upper surface 32B of the rear rail 32, the bent portion 75 is located slightly upward from the upper surface 32B of the rear rail 32. The cable support portion 74 is an L-shaped portion formed by the horizontal plate 72 and the vertical plate 73. The horizontal plate 72 is connected to the bent portion 75 and extends in the vehicle width direction. The vertical plate 73 extends upward from the horizontal plate 72. An inner portion of the clamp 62 of the high-voltage cable 60 is attached to an upper portion of the vertical plate 73. Therefore, the high-voltage cable 60 is attached to the vertical plate 73 so that the cable main body 61 is located outside the vertical plate 73.

As described above, since the bent portion 75 is located slightly above the upper surface 32B of the rear rail 32, the horizontal plate 72 is also located slightly above the upper surface 32B of the rear rail 32. The horizontal plate 72 extends from the bent portion 75 to the outside of the outer end surface 52A of the valve unit 52. Thus, the bracket 70 supports the high-voltage cable 60 between the upper surface 32B of the rear rail 32 and the lower end 52B of the valve unit 52 and outside the outer end surface 52A of the valve unit 52 in the vehicle width direction.

As shown in FIG. 4, the length L1 between the bent portion 75 and the vehicle width direction outer end of the high-voltage cable 60 is shorter than the length H1 between the bent portion 75 and the lower end 52B of the valve unit 52.

Next, deformation of the bracket 70 when the electric vehicle 100 configured as described above rolls and the power generation unit 20 comes into contact with the ground will be described. When the electric vehicle 100 rolls over, the ground enters a rollover ground entering line 91 (indicated by a one-dot chain line in FIG. 4) connecting the outer surface 16A of the mounting rail 16 fixed to the roof 11 and the upper end of the outer end surface 52A of the valve unit 52. At this time, a lateral impact force is applied to the high-voltage cable 60 from the vehicle width direction outer side toward the vehicle width direction center as indicated by a white arrow in FIG. 4. Since the high-voltage cable 60 is connected to the vertical plate 73 above the horizontal plate 72 of the bracket 70, a counterclockwise rotation moment is applied to the bent portion 75 by the impact force. Due to this rotation moment, the L-shaped cable support portion 74 is bent and deformed counterclockwise toward the vehicle width direction inner side about the bent portion 75 as indicated by broken line arrows 92 and 93 in FIG. 4.

As described above, the length L1 between the bent portion 75 and the outer end of the high-voltage cable 60 is shorter than the length H1 between the bent portion 75 and the lower end 52B of the valve unit 52. Therefore, when the cable support portion 74 is bent and deformed toward the vehicle width direction inner side about the bent portion 75, the high-voltage cable 60 is stored between the upper surface 32B of the rear rail 32 and the lower end 52B of the valve unit 52 and inside the outer end surface 52A of the valve unit 52, as indicated by the broken line in FIG. 4. Since the outer end surface 52A of the valve unit 52 having high rigidity comes into contact with the ground, the ground does not enter the vehicle width direction inner side of the rollover ground entering line 91. Therefore, a region located between the upper surface 32B of the rear rail 32 and the lower end 52B of the valve unit 52 and inside the outer end surface 52A of the valve unit 52 serves as a living space of the high-voltage cable 60 when the electric vehicle 100 rolls. Therefore, it is possible to prevent the high-voltage cable 60 from coming into contact with the ground and being damaged when the electric vehicle 100 rolls.

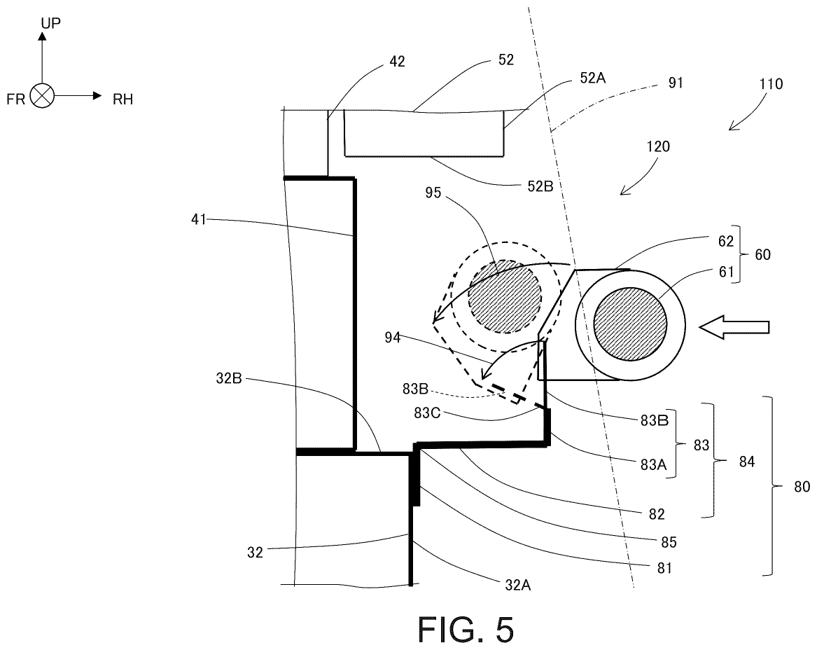

Next, an electric vehicle 110 according to another embodiment will be described with reference to FIG. 5. The same parts as those of the electric vehicle 100 described with reference to FIGS. 1 to 4 are denoted by the same reference numerals, and description thereof will be omitted.

As shown in FIG. 5, in the electric vehicle 110, a power generation unit 120 is mounted on a roof 11. The power generation unit 120 has the same configuration as the power generation unit 20 except that the high-voltage cable 60 is supported by a bracket 80 instead of the bracket 70 described with reference to FIGS. 1 to 4.

As illustrated in FIG. 5, the bracket 80 is a strip-shaped bent plate member including a fixing portion 81, a bent portion 85, and a cable support portion 84. The cable support portion 84 is an L-shaped portion formed by the horizontal plate 82 and the vertical plate 83. Since the configurations of the fixing portion 81, the bent portion 85, and the horizontal plate 82 are the same as those of the fixing portion 71, the bent portion 75, and the horizontal plate 72 of the bracket 70, description thereof will be omitted.

The vertical plate 83 includes a lower half portion 83A having the same thickness as that of the horizontal plate 82 and an upper half portion 83B having a thickness smaller than that of the lower half portion 83A. An inner portion of the clamp 62 of the high-voltage cable 60 is attached to an upper portion of the upper half portion 83B. Therefore, the high-voltage cable 60 is attached to the upper half portion 83B such that the cable main body 61 is located outside the vertical plate 83.

When the electric vehicle 110 configured as described above rolls over, a lateral impact force is applied to the high-voltage cable 60 from the vehicle width direction outer side toward the vehicle width direction center as indicated by a white arrow in FIG. 5. Since the high-voltage cable 60 is connected to the upper portion of the upper half portion 83B, a counterclockwise rotation moment is applied to the upper half portion 83B by the impact force. This rotational moment concentrates on the boundary 83C between the upper half portion 83B and the lower half portion 83A where the thickness has changed. Therefore, the upper half portion 83B is bent and deformed counterclockwise toward the vehicle width direction inner side about the boundary 83C by the impact force as indicated by arrows 94 and 95 in FIG. 5. Accordingly, as indicated by a broken line in FIG. 5, a part of the high-voltage cable 60 is stored in a region located between the upper surface 32B of the rear rail 32 and the lower end 52B of the valve unit 52 and inside the outer end surface 52A of the valve unit 52. In addition, the high-voltage cable 60 as a whole is stored on the inner side of the rollover ground entering line 91. Accordingly, it is possible to prevent the high-voltage cable 60 from coming into contact with the ground and being damaged when the electric vehicle 110 rolls.

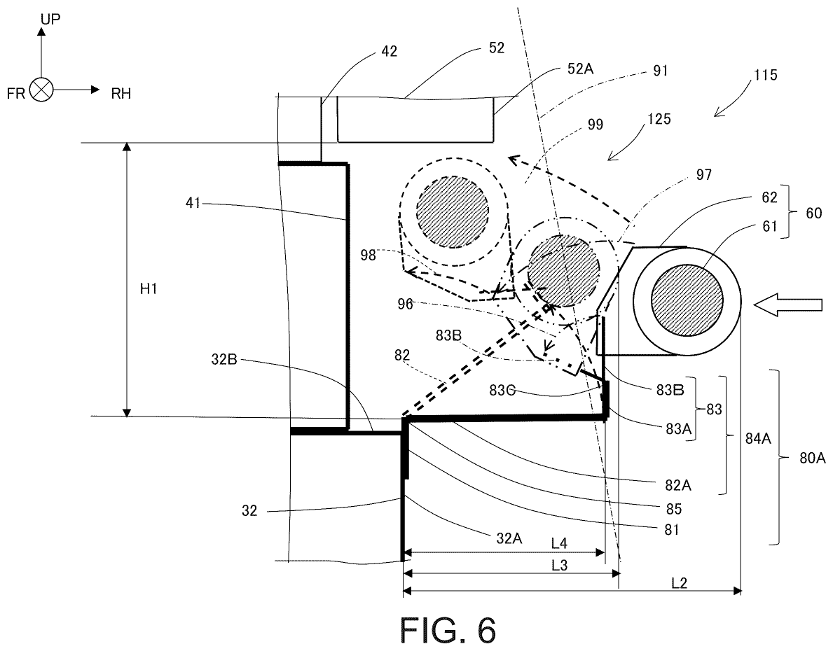

Next, an electric vehicle 115 according to another embodiment will be described with reference to FIG. 6. The same parts as those of the electric vehicle 110 described with reference to FIG. 4 are denoted by the same reference numerals, and description thereof will be omitted.

As shown in FIG. 6, in an electric vehicle 115, a power generation unit 125 is mounted on a roof 11. The power generation unit 125 has the same configuration as the power generation unit 120 except that the high-voltage cable 60 is supported by a bracket 80A instead of the bracket 80 described with reference to FIG. 4.

The bracket 80A has a horizontal plate 82A and a vertical plate 83. The length of the horizontal plate 82A is longer than the length of the horizontal plate 82 of the bracket 80. Therefore, the position of the high-voltage cable 60 supported by the bracket 80A is located outside the position of the high-voltage cable 60 supported by the bracket 80. Here, the length L4 of the horizontal plate 82 is shorter than the length H1 between the bent portion 85 and the lower end 52B of the valve unit 52. The length L2 between the bent portion 85 and the outer end of the high-voltage cable 60 is longer than the length H1 between the bent portion 85 and the lower end 52B of the valve unit 52. The configuration of other parts of the bracket 80A is the same as the configuration of the bracket 80 described with reference to FIG. 4.

When the electric vehicle 115 configured as described above rolls over, as in the case of the rollover of the electric vehicle 110 described with reference to FIG. 5, the upper half portion 83B bends and deforms counterclockwise inward about the boundary 83C as indicated by the arrows 96 and 97 of the one-dot chain line in FIG. 6 by the impact force. However, since the length of the horizontal plate 82A is longer than that of the horizontal plate 82, a part of the high-voltage cable 60 is stored in a region located inward of the rollover ground entering line 91, but the other part of the high-voltage cable 60 is not stored in a region located inward of the rollover ground entering line 91. For this reason, a part thereof remains on the outer side of the rollover ground entering line 91, and an impact force toward the inner side continues to be applied to the high-voltage cable 60. Then, as with the bracket 70 described with reference to FIG. 4, the L-shaped cable support portion 84A is bent and deformed counterclockwise inward about the bent portion 85 as indicated by the broken arrows 98 and 99 in FIG. 6 by the impact force.

As shown in FIG. 6, the length between the bent portion 85 and the outer end of the high-voltage cable 60 when the upper half portion 83B is bent and deformed is a length L3 shorter than the initial length L2. The length L3 is shorter than the length H1 between the bent portion 85 and the lower end 52B of the valve unit 52. As described above, since the length L3 is shorter than the length H1, when the cable support portion 84A is bent and deformed counterclockwise toward the vehicle inner side about the bent portion 85, the high-voltage cable 60 is stored in a region located between the upper surface 32B of the rear rail 32 and the lower end 52B of the valve unit 52 and further inward than the outer end surface 52A of the valve unit 52. Accordingly, it is possible to prevent the high-voltage cable 60 from coming into contact with the ground and being damaged when the electric vehicle 115 rolls.

In the above description, the gas fuel tank is the hydrogen tank 50 that stores the hydrogen gas, and the FC module 40 is a fuel cell module that generates power using the hydrogen gas supplied from the hydrogen tank 50 as fuel. However, a configuration other than this embodiment may be employed. For example, the FC module 40 may generate electric power by a fuel cell using natural gas as fuel, and the gas fuel tank may be configured by a natural gas tank.

In addition, in the above description, the electric vehicle 100 has been described as an electric bus, but is not limited thereto, and may be, for example, an electric truck, an electric SUV, an electric commercial vehicle, or the like as long as it is a fuel cell electric vehicle in which the power generation unit 20 is mounted on the roof 11.

1. A fuel cell electric vehicle comprising:
a frame fixed on a roof;
a high voltage cable routed along the frame in the vehicle longitudinal direction;
a bracket attached to the frame, the bracket extending outward in the vehicle width direction from the frame and configured to support the high voltage cable at the outside of the frame; and
a gas fuel tank mounted on the frame such that a longitudinal direction of the gas fuel tank lies along the vehicle width direction, the gas fuel tank having a valve unit which is attached to an end, in the longitudinal direction, of the gas fuel tank; wherein
the gas fuel tank is mounted on the frame such that the valve unit protrudes further outward in the vehicle width direction than the frame, and
the bracket is bent and deformed toward the inside in the vehicle width direction when an impact force is applied from the outside in the vehicle width direction, to store the high-voltage cable in a region located inward of an outer end surface of the valve unit in the vehicle width direction.

2. The fuel cell electric vehicle according to claim 1, wherein
the bracket supports the high voltage cable between an upper surface of the frame and a lower end of the valve unit and outside the outer end surface of the valve unit in the vehicle width direction, and
the bracket is bent and deformed toward the inside in the vehicle width direction when an impact force is applied from the outside in the vehicle width direction, to store the high voltage cable between the upper surface of the frame and the lower end of the valve unit and in the region located inward of the outer end surface of the valve unit in the vehicle width direction.

3. The fuel cell electric vehicle according to claim 1, wherein
the bracket comprises;
a fixing portion fixed to an outer surface of the frame in the vehicle width direction,
a bent portion bent outwardly in the vehicle width direction from an upper end of the fixing portion, and
an L-shaped cable support portion that is connected to an outer side of the bent portion in the vehicle width direction, extends upward, and is configured to hold the high-voltage cable on an outer side, in the vehicle width direction, of an upper portion, wherein
when an impact force is applied from the outside in the vehicle width direction, the cable support portion is pivoted inwardly in the vehicle width direction about the bent portion, to store the high voltage cable in the region located inward of the outer end surface of the valve unit in the vehicle width direction.

4. The fuel cell electric vehicle according to claim 2, wherein
the bracket comprises;
a fixing portion fixed to an outer surface of the frame in the vehicle width direction,
a bent portion bent outwardly in the vehicle width direction from an upper end of the fixing portion, and
an L-shaped cable support portion that is connected to an outer side of the bent portion in the vehicle width direction, extends upward, and is configured to hold the high-voltage cable on an outer side, in the vehicle width direction, of an upper portion, wherein
when an impact force is applied from the outside in the vehicle width direction, the cable support portion is pivoted inwardly in the vehicle width direction about the bent portion, to store the high voltage cable in the region located inward of the outer end surface of the valve unit in the vehicle width direction.

5. The fuel cell electric vehicle according to claim 1, wherein
the bracket comprises,
a fixing portion fixed to an outer surface of the frame in the vehicle width direction,
a bent portion bent outwardly in the vehicle width direction from an upper end of the fixing portion, and
an L-shaped cable support portion connected to an outer side of the bent portion in the vehicle width direction, extending upward, and configured to hold the high voltage cable on an outer side, in the vehicle width direction, of an upper portion,
the cable support portion comprises,
a lateral plate connected to the bent portion and extending in the vehicle width direction, and
a vertical plate extending upward from the lateral plate and configured to hold the high-voltage cable on an outer side of an upper portion in a vehicle width direction,
the thickness of the upper half of the vertical plate is smaller than the thickness of the lower half, and
when an impact force is applied from the outside in the vehicle width direction, the upper half portion is pivoted inwardly in the vehicle width direction about a boundary between the upper half portion and the lower half portion, to store at least a portion of the high-voltage cable between the upper surface of the frame and the lower end of the valve unit and in the region located inward of the outer end surface of the valve unit in the vehicle width direction.

6. The fuel cell electric vehicle according to claim 2, wherein
the bracket comprises,
a fixing portion fixed to an outer surface of the frame in the vehicle width direction,
a bent portion bent outwardly in the vehicle width direction from an upper end of the fixing portion, and
an L-shaped cable support portion connected to an outer side of the bent portion in the vehicle width direction, extending upward, and configured to hold the high voltage cable on an outer side, in the vehicle width direction, of an upper portion,
the cable support portion comprises,
a lateral plate connected to the bent portion and extending in the vehicle width direction, and
a vertical plate extending upward from the lateral plate and configured to hold the high-voltage cable on an outer side of an upper portion in a vehicle width direction,
the thickness of the upper half of the vertical plate is smaller than the thickness of the lower half, and
when an impact force is applied from the outside in the vehicle width direction, the upper half portion is pivoted inwardly in the vehicle width direction about a boundary between the upper half portion and the lower half portion, to store at least a portion of the high-voltage cable between the upper surface of the frame and the lower end of the valve unit and in the region located inward of the outer end surface of the valve unit in the vehicle width direction.

7. The fuel cell electric vehicle according to claim 5, wherein
after the upper half portion is pivoted inwardly in the vehicle width direction about the boundary between the upper half portion and the lower half portion when an impact force is applied from the outside in the vehicle width direction,
the cable support portion including the lower half portion and the lateral plate is pivoted inwardly in the vehicle width direction about the bent portion, and
the high voltage cable is stored between the upper surface of the frame and the lower end of the valve unit in the region located inward of the outer end surface of the valve unit in the vehicle width direction.

8. The fuel cell electric vehicle according to claim 6, wherein
after the upper half portion is pivoted inwardly in the vehicle width direction about the boundary between the upper half portion and the lower half portion when an impact force is applied from the outside in the vehicle width direction,
the cable support portion including the lower half portion and the lateral plate is pivoted inwardly in the vehicle width direction about the bent portion, and
the high voltage cable is stored between the upper surface of the frame and the lower end of the valve unit in the region located inward of the outer end surface of the valve unit in the vehicle width direction.
